(19) United States
(12) Patent Application Publication
(10) Pub. No.: US 2022/0391463 A1
(43) Pub. Date: Dec. 8, 2022

(54) CONTACT INFORMATION DISTRIBUTION

(71) Applicant: Jan Gerhardus EHLERS, Centurion (ZA)

(72) Inventor: Jan Gerhardus EHLERS, Centurion (ZA)

(21) Appl. No.: 17/830,774

(22) Filed: Jun. 2, 2022

Related U.S. Application Data
(60) Provisional application No. 63/195,879, filed on Jun. 2, 2021.

(51) Int. Cl. G06F 16/9538; G06Q 50/00; G06Q 30/02; G06F 16/951; G06F 16/906

(52) U.S. Cl. CPC G06F 16/9538; G06Q 50/01; G06Q 30/0282; G06F 16/951; G06F 16/906

(57) ABSTRACT

The invention relates to a method of distributing contact information, which includes displaying an image of a second user via a first application being executed on an electronic device of a first user; capturing a command on the first application to select an image of the second user; calling a second application; accessing data of the second user in a user database in the second application; displaying a menu to the data of the second user from the user information database in the second application; and providing a return path to the first application in the second application.

### FIELD OF THE INVENTION

This invention relates to contact information distribution. In particular, the invention relates to a method of distributing contact information and to a contact distribution system.

### BACKGROUND OF THE INVENTION

A multitude of mobile applications displays profile images of users. For the human user, a profile picture is the best way to identify a user because of the strong visual processing in the brain.

Profile pictures are often used in conjunction with other descriptive user fields, such as a name, surname, a description of the user and the like.

Profile pictures are mostly used in applications where a particular image of a person is used to identify the person's profile in a social media application, a messaging application and the like.

Often when searching for a particular user, an operator scrolls through many pages of profile pictures in order to locate the correct user. This process of image searching by operators spans multiple applications, whether social media, messaging applications, contact lists, or the like.

Of all the descriptors of users, a visual image of a user forms the strongest link to the desired user.

All other user data is therefore secondary to the primary identifier, being the user image.

The inventor identified a requirement to access secondary user data in an efficient manner by using the primary user identifier, being the image of the user.

### SUMMARY OF THE INVENTION

A method of distributing contact information, which includes

displaying an image of a second user via a first application being executed on an electronic device of a first user;

capturing a command on the first application to select an image of the second user;

calling a second application;

accessing data of the second user in a user database in the second application;

displaying a menu to the data of the second user from the user information database in the second application; and

providing a return path to the first application in the second application.

The step of displaying an image of the second user via the first application being executed on the electronic device of the first user may also include the step of the displaying the image of the second user in a contact list of the first user. The contact list may display the images of a plurality of users of the first and second applications.

The step of displaying an image of the second user via the first application being executed on the device of the first user may further include the step of the second user granting the first user access to display the image of the second user in the contact list of the first user.

The step of accessing a user information database in the second application may include accessing a contact database in the second application to determine a category of contact that the second user is of the first user. The category of contact may include a personal contact and a business contact. The category of contact may be associated with symbols that indicate the category of contact, the symbols displayed along with the image of the second user. The symbol may include a “P” for a personal contact, alternatively, a “B” for a business contact.

The menu to the user information database may include any one of data fields of the user information database and links to sub-menus of the user information database.

The links to the sub-menu may be interactive links of the second application. The sub-menu may include an index to any one or more of the following categories:
a personal contact menu; and
a business contact menu.

The index to the sub-menu relating to the personal contact menu and the business contact menu may differ such that the second user has control over the categories and data fields viewed by the first user.

The personal contact information menu may include the following categories and data fields:
a name of a user;
a surname of a user;
contact details of a user;
personal photos;
personal videos;
personal notes;
location of the user;
employment status of a user; and
at least one social media link of a personal account of the second user

The personal photos of the second user may include photos uploaded to the user information database associated with the second application of the second user.

The personal videos of the second user may include videos uploaded to the user information database associated with the second application of the second user.

The personal notes of the second user may include any one or more of the following: a status of the second user, biography of the second user or the like.

The contact details of the second user may include any one or more of the following: mobile number, landline number, email address, physical address or the like.

The location of the second user may be determined using the GPS of the electronic device of the second user, which electronic device hosts the first application and the second application. In one embodiment, the location of the second user may be shared via the second application with the first user. In another embodiment, the first user may allow the second user to view the first user's location when the second user is located within a set range. In this example, the second user may receive a notification from the first user, with the acceptance of the notification allowing the second user to view the first user's location.

The employment status of the user may be displayed as unemployed, open for new opportunities, or the like.

The at least one social media link of the personal account of the second user may include any one or more of the following: Facebook, Instagram, Twitter or the like.

The business contact information menu may include the following categories:
description of business;
business rating; in which the business rating includes a rating of the performance of the business as it relates to a specific goods or service;
location of the business;
marketing material of the business;
photos of the business;
description of goods and services provided;
a website of the second user;
at least one social media link of a business and/or personal account of the second user;
an overview of a business of the second user;
business details of the second user;
contacts in a contact database which are associated with the second user;
reviews of contacts in a contact database which are associated with the second user;
nominated suppliers or business interests; and
search function

The business rating may include a rating of the performance of the business as it relates to a specific goods or service. In one embodiment, the business may be rated on a prorate bases using a number of stars ranging from 1 to 5. In this example, a star rating of 1, may be indicative of poor service, and a star rating of 5, may be indicative of excellent service.

The business location may include the physical and postal address of the business contact category. The location of the business may be viewed by all users of the first and second applications. In one embodiment, the location of the business may be viewed by selected first users.

The at least one social media link of a business account of the second user may include any one or more of the following: Facebook, Instagram, Twitter or the like.

The contacts in the contact database which are associated with the second user may include contacts that are users of the first application and the second application.

The reviews of contact in the contact database which are associated with the second user may include the review of goods or services provided by contacts which are users of the first application and the second application that are business contact categories of the second user.

The nominated suppliers or business interests may include suppliers or business interests of which the second user has made of use and subsequently nominated for possible use by the first user in relation to specific goods or services.

The search function may be executable to allow a user of the first and second application to search their personal contact categories and business contact categories, and in turn, search these personal contact categories' and business categories' categories to find suppliers of goods or services. The search function may be executable to make the users' Curriculum Vitae (CV) available when searching for a field of expertise relating to goods or service when such user's employment status is unemployed or open for new opportunities, or the like.

In one embodiment, the personal contact category that the second user is of the first user may have access to both the personal contact information menu and the business contact information menu whereas the business contact category that the second user is of the first user may have access only to the business contact information menu.

In another embodiment the business category contact that the second user is of the first user may grant access to the business category to have access to some or all of the personal category contact information menu.

It is to be appreciated that the first application may be a native application executed on the electronic device. The second application may be any one of a native application executed on the electronic device and a non-native application executed on a remote processor to which the electronic device is operably connected. For example, the second application may be in the form of a remotely hosted application or the native application may be operatively connectable to a remote database.

It is to be appreciated that the first application may share contact details stored on the electronic device with the second applications.

The invention extends to a contact distribution system, which includes

a first application executable on an electronic device to display an image of a second user;

selection means operable to capture a command on the first application being executed on the electronic device of a first user to select the image of the second user;

calling means operable to read the command on the first application and to call a second application through which data of a second user in a user information database is accessible; and

a second application on which a user information database is hosted, operable to present the user information database on the electronic device of the first user.

The second user may be a user of the first application and the second application. In one embodiment, the second user may grant the first user permission to access the data of the second user in the user information database.

The permission granted to the first user by the second user may be in the form of a request for permission which may be denied or confirmed. The request for permission may be in one of the following forms: friend request, request to follow, or the like.

The electronic device may be configured to launch the first application and the second application. In one embodiment, the second application may be pre-associated with the first application.

It is to be appreciated that the first application may be a native application executed on the electronic device. The second application may be any one of a native application executed on the electronic device and a non-native application executed on a remote processor to which the electronic device is operably connected. For example, the second application may be in the form of a remotely hosted application or the native application may be operatively connectable to a remote database.

The first application may incorporate a contact list of the first user, which contact list displays the image of the second user. In one embodiment, the contact list may display the images of a plurality of second users that are users of the first application and the second application.

The images of the second users in the contact list of the first user may be displayed as an icon whereby the second application may be accessed.

The second application may be executable to allow the image of the second user as displayed on the first application of the first user to be interchangeable between frames, which frames indicates a status of the second user. A first frame indicates that user information is accessible by selecting the image, a second frame indicates that new user information has been uploaded to the user database and no frame indicates that no new user information has been uploaded to the user database.

The first application may be executable in the background of the electronic device and second application may be executable in the foreground of the electronic device.

The electronic device may include a memory module, a display module, a controller module and a user interface.

The memory module may be configured to store data generated or received by the electronic device. In one embodiment, the memory module may be configured to store the second application associated with the first application.

The display module may be configured to display a user interface generated by the first application on the electronic device and a user interface generated by the second application on the electronic device.

The controller module may be configured to detect the selection means performed on the first application.

In one embodiment, the controller module may be configured to translate a language of selection means to a language of the calling means to call and subsequently launch the second application on the user interface of the electronic device.

The selection means operable to capture the command on the first application may include a gesture performed by the first user relative the image of the second user. The gesture may include any one or more of the following: long pressing of the image of the second user, single tap of the image of the second user or the like.

The calling means may include an Application Programming Interface (API). In one embodiment, the API may employ a common cross language technique to enable the communication between the first application and the second application of the first user on the electronic device.

In one embodiment, the callings means may include Remote Procedure Calls (RPC) interfaces that allow the first application to communicate with the second application.

The user interface may include a user interface of the first application and a user interface of the second application.

The electronic device may include any or more of the following: a mobile device, a tablet or the like.

The user information database may include data of users as well as categories of associations between users. The categories of users may include a personal contact and a business contact.

In one embodiment, the categories of users may be identified by a symbol associated with the category of users displayed along with the image of the second user. The symbol may include a “P” for personal contact categories alternatively a “B” for business contact categories.

The user information database may associate selected data fields with each of the personal contact and business contact categories respectively. The data fields of the personal contact categories and the business contact categories may differ.

The data fields associated with the personal contact category may include:
a name of a user;
a surname of a user;
contact details of a user;
personal photos;
personal videos;
personal notes;
location of a user;
employment status of a user; and
at least one social media link of a personal account of the second user

The data fields associated with the personal contact category may be displayed on the user interface of the second application.

The personal photos of the second user may include photos uploaded to the user information database associated with the second application of the second user.

The personal videos of the second user may include videos uploaded to the user information database associated with the second application of the second user.

The personal notes of the second user may include any one or more of the following: a status of the second user, biography of the second user or the like.

The contact details of the second user may include any one or more of the following: mobile number, landline number, email address, physical address or the like.

The location of the second user may be determined using the GPS of the electronic device of the second user, which electronic device hosts the first application and the second application. In one embodiment, the location of the second user may be shared via the second application with the first user. In another embodiment, the first user may allow the second user to view the first user's location when the second user is located within a set range. In this example, the second user may receive a notification from the first user, with the acceptance of the notification allowing the second user to view the first user's location.

The employment status of the user may be displayed as unemployed, open for new opportunities, or the like.

The at least one social media link of the personal account of the second user may include any one or more of the following: Facebook, Instagram, Twitter or the like. In one embodiment, when accessing the social media link of the personal account of the second user, the first user may be redirected to a user interface associated with the social media account.

The data fields associated with the business contact category may include:
description of the business;
business rating; in which the business rating includes rating of the performance of the business as it relates to a specific goods or service;
business location;
marketing material of the business;
photos of the business;
description of goods and services provided;
a website of the second user;
at least one social media link of a business and/or personal account of the second user;
an overview of a business of the second user;
business details of the second user;
contacts in a contact database which are associated with the second user;
reviews of contacts in a contact database which are associated with the second user;
nominated suppliers or business interests; and
search function

The data fields associated with the business contact category may be displayed on the user interface of the second application.

The business rating may include a rating of the performance of the business as it relates to a specific goods or service. In one embodiment, the business may be rated on a prorate bases using a number of stars ranging from 1 to 5. In this example, a star rating of 1, may be indicative of poor service, and a star rating of 5, may be indicative of excellent service.

The business location may include the physical and postal address of the business contact category. The location of the business may be viewed by all users of the first and second applications. In one embodiment, the location of the business may be viewed by selected first users.

The at least one social media link of a business account of the second user may include any or more of the following: Facebook, Instagram, Twitter or the like. In one embodiment, when accessing the social media link of the business account of the second user, the first user may be redirected to a user interface associated with the social media account.

The contacts in the contact database which are associated with the second user may include contacts that are users of the first application and the second application that provide and supply goods and services.

The reviews of contacts in the contact database which are associated with the second user may include the review of the goods or services provided by contacts which are users of the first application and second application that are business contact categories of the second user.

The nominated suppliers or business interests may include suppliers or business interests of which the second user has made of use of and has subsequently nominated for possible use by the first user in relation to specific goods or services.

The search function may be executable to allow a user of the first and second application to search their personal contact categories and business contact categories, and in turn, search these personal contact categories' and business categories' categories to find suppliers of goods or services. In one embodiment, the search may be executable to make the users' Curriculum Vitae (CV) available when searching for a field of expertise relating to goods or service when such user's employment status unemployed or open for new opportunities, or the like.

The search function may be performed using keywords.

In one embodiment, the personal contact category that the second user is of the first user may have access to both the personal contact information menu and the business contact information menu whereas the business contact category that the second user is of the first user may have access only to the business contact information menu.

In another embodiment the business category contact that the second user is of the first user may grant access to the business category to have access to some or all of the personal category contact information menu.

The user information database may include a cloud database. The data fields associated with personal contact category and the business contact category may be uploaded to the cloud database accessible by the first user through the calling means.

The contact distribution system may be executable to create a landing page of each business searched in the business contact category as based on the keywords associated with the business contact category uploaded to the user information database.

The second application may also be executable to allow the second user to upload and consequently store photos in the user information database associated with the second application. It is to be appreciated that the user information database may allow the second user to upload and store photos in the user information database as an alternative to the upload and storage of photos on social media platforms.

The second application may further be executable to allow the second user to change, add to or remove selected data fields on the user information database.

In one embodiment, the second application may also be executable to allow the second user to edit the image of the second user as displayed on the first application of the first user. Alternatively, the image of the second user may be changed by way or rotating the current photo with photos from an album, which rotation occurs after a predetermined lapse of time, by way of random rotation or the like.

The contact distribution system may further include a notification function whereby the second application is executable to notify the first user when the second user uploads user information pertaining to the data fields of the personal contact category and the business contact category.

The invention is now described, by way of non-limiting example, with reference to the accompanying figures:

### BRIEF DESCRIPTION OF THE DRAWINGS

In the figure(s):

FIG. 1 shows a flow-diagram representing a method of distributing contact information in accordance with one aspect of the invention

FIG. 2 shows a schematic view of a contact distribution system in accordance with another aspect of the invention.

In the figures, like reference numerals denote like parts of the invention unless otherwise indicated.

### DETAILED DESCRIPTION OF EMBODIMENT OF THE INVENTION

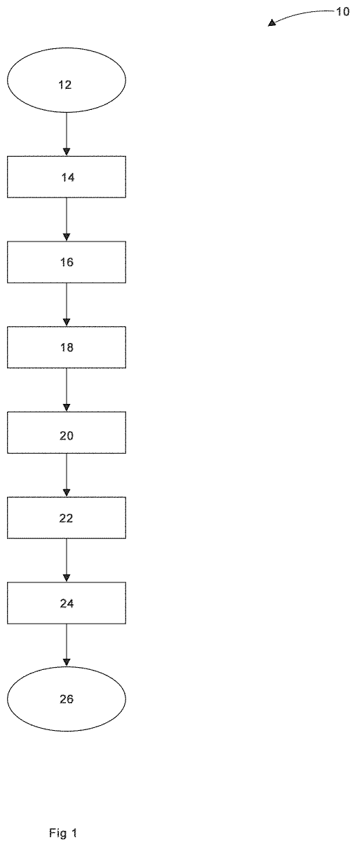

In FIG. 1, reference numeral (10) refers to a method of distributing contact information. The method (10) starts at reference numeral 12.

At 14, the method (10) includes the step of displaying an image of a second user via a first application being executed on an electronic device of a first user.

At 16, the method (10) includes the step of capturing a command on the first application to select an image of the second user.

At 18, the method (10) includes the step of calling a second application.

At 20, the method (10) includes the step of accessing date of the second user in a user database in the second application.

At 22, the method (10) includes the step of displaying a menu to data of the second user from the user information database if the second application.

At 24, the method (10) includes the step of providing a return path to the first application in the second application.

The method (10) ends at reference numeral 26.

The step of displaying an image of the second user via the first application being executed on the electronic device of the first user also includes the step of the displaying the image of the second user in a contact list of the first user. The contact list displays the images of a plurality of users of the first and second applications.

The step of displaying an image of the second user via the first application being executed on the device of the first user further includes the step of the second user granting the first user access to display the image of the second user in the contact list of the first user.

The step of accessing a user information database in the second application includes accessing a contact database in the second application to determine a category of contact that the second user is of the first user, which category of contact includes a personal contact and a business contact.

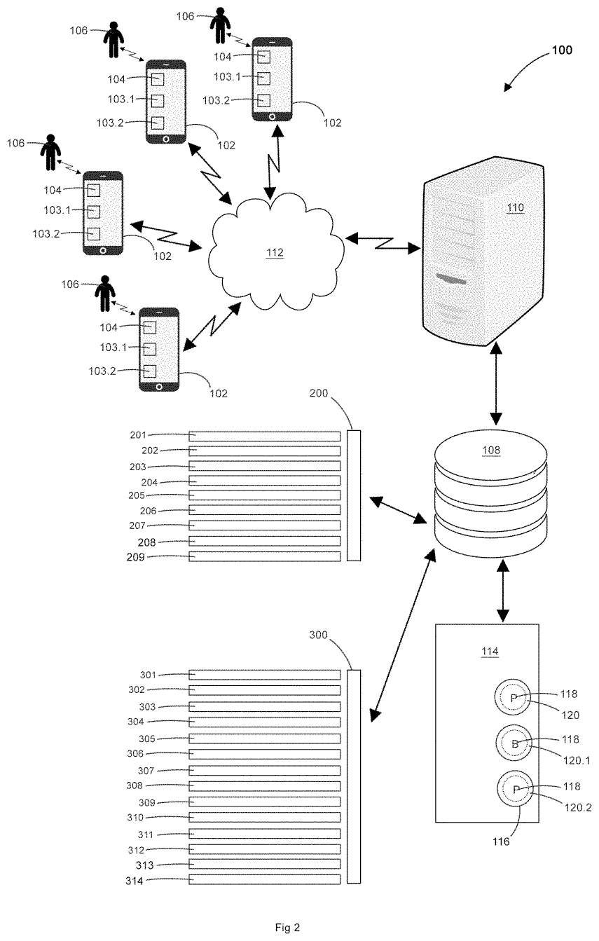

In FIG. 2, reference numeral (100) refers to a contact distribution system in accordance with another embodiment of the invention.

The contact distribution system (100) includes a first application executable on an electronic device (102) to display an image of a second user (104).

The contact distribution system (100) includes selection means operable to capture a command on the first application being executed on the electronic device (102) of a first user (106) to select the image of the second user (104).

The electronic device (102) is a mobile phone (102) of the first user (106) and the second user (106).

The contact distribution system (100) includes calling means operable to read the command on the first application and to call a second application through which data of a second user (104) in a user information database (108) is accessible.

The contact distribution system (100) includes a second application on which the user information database (108) is hosted, operable to present the user information database (108) on the mobile phone (102) of the first user (106).

The second user (104) is a user of the first application and the second application. The second user (104) grants the first user (106) permission to access the data of the second user (104) in the user information database (108) by accepting a request to follow the second user (104) sent by the first user (106).

The mobile phone (102) is configured to launch the first application and the second application, the second application is pre-associated with the first application.

The first application is a native application executed on the mobile phone (102). The second application is a non-native application executed on a remote processor (110) to which the mobile phone (102) is operably connected via the internet (112).

The first application incorporates a contact list (114) of the first user (106), which contact list (114) displays the images (116) of a plurality of second users (104) that are users of the first application and the second application as icons (116) whereby the second application is accessed.

The second application is executable to allow the image (116) of the second user (104) as displayed on the first application of the first user (106) to be interchangeable between frames (120), which frames (120) indicates a status of the second user (104). The first frame (120.1) indicates that user information is accessible by selecting the image (116), the second frame (120.2) indicates that new user information has been uploaded to the user database (108) and no frame (120) indicates that no new user information has been uploaded to the user database (108).

The first application is executable in the background of the mobile phone (102) and second application is executable in the foreground of the mobile phone (102).

The mobile phone (102) includes a memory module (not shown), a display module (not shown), a controller module (not shown) and a user interface (103). The memory module is configured to store the second application associated with the first application. The display module is configured to display the user interface (103.1) generated by the first application on the mobile phone (102) and the user interface (103.2) generated by the second application on the electronic device (102). The controller module is configured to detect the selection means performed on the first application, specifically, the controller module translates a language of selection means to a language of the calling means to call and subsequently launch the second application on the user interface (103.2) of the mobile phone (102).

The selection means captures the command on the first application as a gesture performed by the first user (106) relative the image (116) of the second user (104), which gesture is the long pressing of the image (116) of the second user (104).

The calling means includes an Application Programming Interface (API) which employs a common cross language technique to enable the communication between the first application and the second application of the first user (106) on the mobile phone (102).

The calling means includes include Remote Procedure Calls (RPC) interfaces that allow the first application to communicate with the second application.

The user information database (108) includes data of users (104) (106) as well as categories of associations between users (104) (106). The categories of users (102) (104) include a personal contact and a business contact that are identified by a symbol (118) associated with the category of users (102) (104) displayed along with the image (116) of the second user (104). The symbol (118) includes a “P” for personal contact categories and a “B” for business contact categories.

The user information database (108) associates selected data fields with each of the personal contact category (200) and business contact category (300), respectively. The data fields of the personal contact categories (200) and the business contact categories (300) differ.

The data fields associated with the personal contact category (200) includes:
a name of a user (201);
a surname of a user (202);
contact details of a user (203);
personal photos (204);
personal videos (205)
personal notes (206);
location of the user (207);
employment status of a user (208); and
a link to a social media account, particularly, Facebook (209)

The data fields associated with the personal contact category (200) are displayed on the user interface (103.2) of the second application.

The personal photos (204) of the second user (104) are photos (204) that have been uploaded to the user information database (108) associated with the second application of the second user (104).

The personal videos (205) of the second user (104) are videos (205) that have been uploaded to user information database (108) associated with the second application of the second user (104)

The personal notes (205) of the second user (104) are a status of the second user (104).

The contact details (203) of the second user (104) include the second user's (104) mobile number, landline number, email address and physical address.

The location (206) of the second user (104) is determined using the GPS of the mobile phone (102) of the second user (104), which location (206) is shared via the second application with the first user (106).

The employment status (208) of the second user (104) displays that the second user (204) is unemployed.

When the first user (106) accesses the social media link (207) to the Facebook account of the second user (104), the first user (106) is redirected to a user interface associated with the social media account. Although not shown, the user interface is displayed on the display module of the mobile phone (102).

The data fields associated with the business contact category (300) include:
description of the business (301);
business rating (302);
business location (303);
marketing material of the business (304);
photos of the business (305);
description of goods and services provided (306);
a website (307) of the second user (104);
a social media link to a business account of the second user (104), particularly Facebook (308);
an overview of a business (309) of the second user (104);
business details (310) of the second user (104));
contacts (311) in a contact database which are associated with the second user (104));
reviews of contacts (312) in a contact database which are associated with the second user (104);
nominated suppliers and business interests (313); and
search function (314)

The data fields associated with the business contact category (300) are displayed on the user interface (103) of the second application.

The business rating includes a rating of the performance of the business as it relates to a specific goods or service. The business is rated on a prorate bases using a number of stars ranging from 1 to 5, specifically, with a star rating of 1, indicating poor service, and a star rating of 5 indicating excellent service.

The business location includes the physical address of the business contact category. The location of the business is viewed only by selected first users.

When accessing the social media link of the business account (306) of the second user (104), the first user (106) is directed to a user interface associated with the social media account (306). Although not shown, the user interface is displayed on the display module of the electronic device (102).

The contacts (309) in the contact database which are associated with the second user (104) are the contacts (309) that are users of the first application and the second application that provide and supply goods and services.

The reviews of contacts (310) in the contact database which are associated with the second user (104) are the reviews of the goods or services provided by contacts (309) which are users (104) (106) of the first application and second application that are business contact categories (300) of the second user (104).

The nominated suppliers and business interests (311) are suppliers and business interests (311) of which the second user (104) has made use of and has subsequently nominated for possible use by the first user (106) in relation to specific goods or services.

The search function (312) is executable to allow the user of the first and second application to search their personal contact categories (200) and business contact categories (300), and in turn, search these personal contact categories' (200) and business contact categories' (300) to find suppliers (311) of goods and services. The users' Curriculum Vitae (CV) is made available when searching for a field of expertise relating to goods or service, specifically, when such user's employment status is indicated as unemployed.

The search function (312) is performed using keywords such as the type of service or goods that the user is looking for.

The personal contact category (200) that the second user (104) is of the first user (106) has access to both the personal contact information menu (200) and the business contact information menu (300) whereas the business contact category (300) that the second user (104) is of the first user (106) only has to the business contact information menu (300).

Advantageously, the business category contact (300) that the second user (104) is of the first user (106) can grant access to the business contact category (300) to have access to all of the personal contact category information menu (200).

The inventor believes that the invention provides to access to a variety secondary user data from an image of the second user, using a single application.

1. A method of distributing contact information, which includes:
displaying an image of a second user via a first application being executed on an electronic device of a first user;
capturing a command on the first application to select the image of the second user;
calling a second application from the electronic device of the first user, the second application being executed on a remote processor;
accessing data of the second user being stored in a user database in the second application;
displaying on the electronic device of the first user a menu to the data of the second user from the user information database in the second application; and
providing a return path to the first application in the second application.

2. A method as claimed in claim 1, in which the step of displaying an image of the second user via the first application, being executed on the electronic device of the first user, also includes the step of the displaying the image of the second user in a contact list of the first user.

3. A method as claimed in claim 1, in which the step of accessing a user information database in the second application includes accessing a contact database in the second application to determine a category of contact that the second user is of the first user.

4. A method as claimed in claim 3, in which the category of contact includes any one or both of a personal contact and a business contact.

5. A method as claimed in claim 1, in which the menu to the user information database includes any one of data fields of the user information database and links to sub-menus of the user information database.

6. A method as claimed in claim 5, in which the sub-menus includes indexes to any one or both of the following categories:
a personal contact menu; and
a business contact menu.

7. A method as claimed in claim 6, in which the personal contact information menu includes the following categories and data fields:
a name of a user;
a surname of a user;
contact details of a user;
personal photos;
personal videos;
personal notes;
location of the user;
employment status of a user; and
at least one social media link of a personal account of the second user

8. A method as claimed in claim 7, in which the location of the second user is determined using the GPS of the electronic device of the second user, which electronic device hosts the first application.

9. A method as claimed in claim 7, in which the location of the second user is shared via the second application with the first user.

10. A method as claimed in claim 6, in which the business contact information menu includes the following categories:
description of business;
business rating; in which the business rating includes a rating of the performance of the business as it relates to a specific goods or service
location of the business;
marketing material of the business;
photos of the business;
description of goods and services provided;
a website of the second user;
at least one social media link of a business and/or personal account of the second user;
an overview of a business of the second user;
business details of the second user;
contacts in a contact database which are associated with the second user;
reviews of contacts in a contact database which are associated with the second user;
nominated suppliers or business interests; and
search function

11. A method as claimed in claim 10, in which the contacts in the contact database which are associated with the second user includes contacts that are users of the first application and the second application.

12. A method as claimed in claim 4, in which the personal contact category that the second user is of the first user has access to both the personal contact information menu and the business contact information menu whereas the business contact category that the second user is of the first user has access only to the business contact information menu.

13. A method as claimed in claim 4, in which the business category contact that the second user is of the first user, grants access to the business category to have access to some or all of the personal category contact information menu.

14. A contact distribution system, which includes:
a first application executable on an electronic device to display an image of a second user;
selection means operable to capture a command on the first application being executed on the electronic device of a first user to select the image of the second user;
calling means operable to read the command on the first application and to call a second application through which data of a second user in a user information database is accessible; and
a second application on which a user information database is hosted, operable to present the user information database on the electronic device of the first user.

15. A contact distribution system as claimed in claim 14, in which the first application incorporates a contact list of the first user, which contact list displays the image of the second user.

16. A contact distribution system as claimed in claim 14, wherein the electronic device includes a memory module, a display module, a controller module and a user interface.

17. A contact distribution system as claimed in claim 16, in which the controller module is configured to detect the selection means performed on the first application.

18. A contact distribution system as claimed in claim 17, in which the selection means, operable to capture the command on the first application, includes a gesture performed by the first user relative the image of the second user.

19. A contact distribution system as claimed in claim 18, in which the gesture includes any one or more of the following: long pressing of the image of the second user, single tap of the image of the second user or the like.

20. A contact distribution system as claimed in claim 14, in which the user information database includes data of users as well as categories of associations between users.

21. A contact distribution system as claimed in claim 20, in which the categories of users includes a personal contact and a business contact.

22. A contact distribution system as claimed in claim 21, in which the user information database associates selected data fields with each of the personal contact and business contact categories respectively.

23. A contact distribution system as claimed in claim 22, in which the data fields associated with the personal contact category include:
a name of a user;
a surname of a user;
contact details of a user;
personal photos;
personal videos;
personal notes;
location of a user;
employment status of a user; and
at least one social media link of a personal account of the second user

24. A contact distribution system as claimed in claim 23, in which the location of the second user is determined using the GPS of the electronic device of the second user, which electronic device hosts the first application and the second application.

25. A contact distribution system as claimed in claim 22, in which the data fields associated with the business contact category include:
description of the business;
business rating; in which the business rating includes a rating of the performance of the business as it relates to a specific goods or service.
business location;
marketing material of the business;
photos of the business;
description of goods and services provided;
a website of the second user;
at least one social media link of a business and/or personal account of the second user;
an overview of a business of the second user;
business details of the second user;
contacts in a contact database which are associated with the second user;
reviews of contacts in a contact database which are associated with the second user;
nominated suppliers or business interests; and
search function

26. A contact distribution system as claimed in claim 21, in which the personal contact category that the second user is of the first user has access to both the personal contact information menu and the business contact information menu whereas the business contact category that the second user is of the first user has access only to the business contact information menu.

27. A contact distribution system as claimed in claim 26, in which the business category contact that the second user is of the first user grants access to the business category to have access to some or all of the personal category contact information menu.
